(19) United States
(12) Patent Application Publication
(10) Pub. No.: US 2007/0181440 A1
(43) Pub. Date: Aug. 9, 2007

(54) Long term, low cost renewably-generated hydrogen storage device and system for farmhouse heating and crop drying

(76) Inventor: Philip Vidal Streich, Platteville, WI (US)

Correspondence Address: Philip Vidal Streich, 30712 County Road B, Platteville, WI, 53818, US

(21) Appl. No.: 11/346,726

(22) Filed: Feb. 3, 2006

(51) Int. Cl. C25B 1/02; B65B 3/00; B64B 1/40

(52) U.S. Cl. 205/637; 244/31; 244/98; 206/.6

(57) ABSTRACT

Novel means for the inexpensive long-term storage on farms of hydrogen produced from wind power or solar energy is provided. The means allow hydrogen stored at near-ambient temperature and pressure to heat farm buildings and crop dryers many months after the hydrogen has been produced, at projected initial cost savings of 92% to 96% of the initial cost of present state of the art storage means. The novel means include inflatable and deflatable balloons protected by shields which, because they are not subjected to the stresses and loads of pressurized gas or liquid heads and because they rest on relatively cheap rural lands, are lightweight and cost-effective despite their bulk.

### BACKGROUND OF THE INVENTION

1. Field of the Invention

The invention relates to the long-term storage of hydrogen generated from wind power or solar energy, and more specifically to the supply, by hydrogen, of winter heat to farm buildings and harvest-time heat to crop dryers.

2. Description of the Invention Background

Generating hydrogen from wind power by water electrolysis is not a new concept, nor is storing the resulting hydrogen for later use (see U.S. Pat. Nos. 5,592,028; 5,900,330; 4,716,736; 6,459,231; 4,462,213; 4,311,011; and 6,591,617).

However, the storage devices and systems proposed so far are all uneconomical for long-term storage on farms. For instance, generating a large volume of hydrogen during the warm months and storing it for house-heating in winter has been economically impractical because of the high initial and operating costs of the means hitherto suggested. Devices like compressed hydrogen cylinders, reversible metal hydrides, liquid hydrogen systems, carbon nanotubes initially loaded with liquid hydrogen, water towers, and other proposed concepts are not cost-effective in the large volumes needed for summer-to-winter or spring-to-fall storage. For example, compressed hydrogen cylinders cost about $75 per standard cubic meter of hydrogen storage capacity; water towers, using pumped water to occupy the space not filled by hydrogen, cost about $500 per standard cubic meter of hydrogen; while reversible metal hydrides currently cost almost $5,000 per standard cubic meter of stored hydrogen. The one economical scheme that has been proposed for the long-term storage of hydrogen is to store it in a sealed cavern. However, most farms do not have caverns on their land or near-by, so this scheme lacks general applicability to the heating of farm buildings and structures. Yet the need for a low-cost, renewable energy source for farmhouse heating and crop drying is growing quite rapidly as fossil fuels get scarcer and ever more expensive.

The main reason why storage means like compressed gas cylinders and water towers are uneconomical for long-term hydrogen storage is the high cost of the relatively heavy enclosures needed to withstand the pressures of gas, liquid, or both. One object of the present invention is to overcome these cost problems so that hydrogen generated at any time of the year can be economically stored on-site and saved for a time when hydrogen's heat of combustion is most needed and therefore most valuable. An installed cost range of about $3 to $6 per standard cubic meter, representing a saving of 92% to 96% of the installed cost of the present state of the art, is a purpose of this invention.

### BRIEF SUMMARY OF THE INVENTION

The present invention provides a relatively inexpensive means of storing on farms, at near-ambient temperature and pressure, hydrogen generated from wind power or solar energy. The means are cost-effective despite their bulk because they can be made from relatively cheap, lightweight materials and because they rest on relatively cheap rural land. The main reason for the low cost of the materials is that the invention eliminates the stresses due to gas or liquid pressures, thus allowing inexpensive, lightweight structures to be used.

The invention comprises means of storing hydrogen in inflatable and deflatable balloons made of metallized polyethalene phthalate polymer film or some other suitable material. The balloons are protected against the elements, including ground water, by shields made of relatively thin-gauge steel or other suitable materials. The shields are ventilated to prevent the build-up of hydrogen from slow leakage through the balloon skins.

The relatively thin gauge, inexpensive steel construction of the shields is made possible because the invention drastically reduces the loads on the structures and the resulting stresses.

### BRIEF DESCRIPTION OF THE SEVERAL VIEWS OF THE DRAWINGS

A complete understanding of the present invention may be obtained by reference to the accompanying drawings, when considered in conjunction with the subsequent detailed description, in which:

FIG. 1 illustrates a flowchart diagram of a method using the inventive hydrogen storage device and heat-producing system of this invention;

FIG. 2 depicts a schematic diagram of the storage device of this invention; and

FIG. 3 is a schematic diagram of the system using the above storage devices in conjunction with farm-based renewable energy sources and farm-based thermal loads.

### DETAILED DESCRIPTION OF THE PREFERRED EMBODIMENT

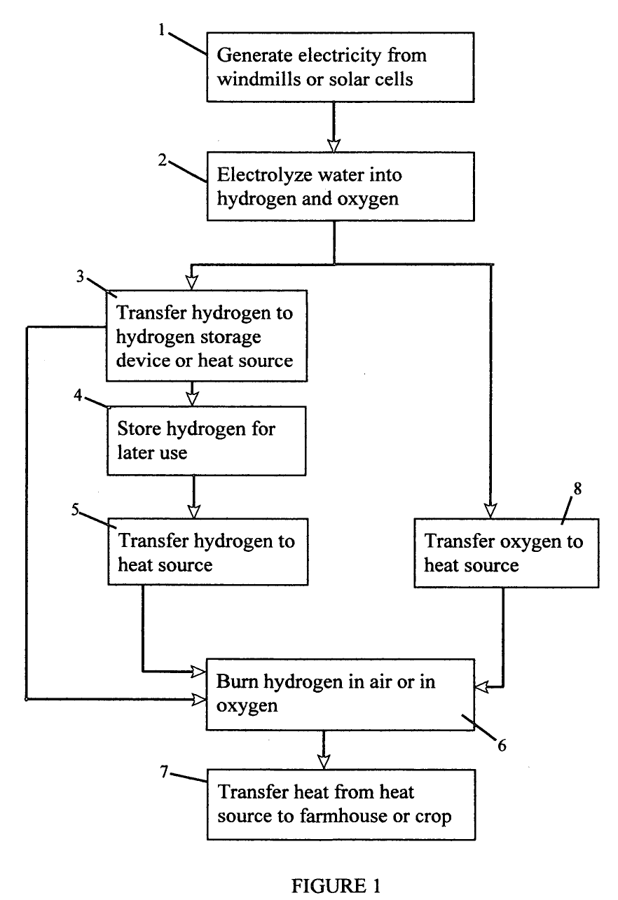

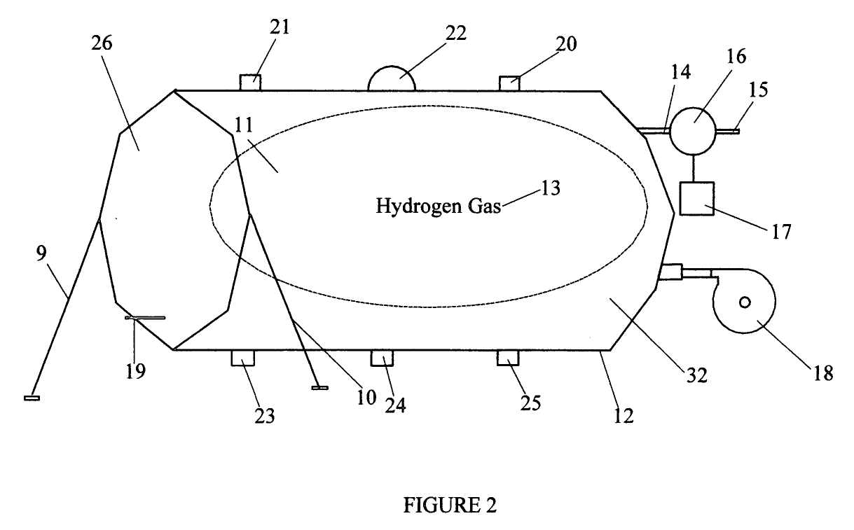

Referring to the drawings, which are for the purpose of illustrating the present preferred embodiment of the invention and not for the purpose of limiting the same, FIG. 1 shows the generation 1 of electric power derived from windmills or solar cells to electrolyze 2 water into hydrogen and oxygen. The hydrogen is transferred 3 at near-ambient temperature and pressure to be stored 4, or to be burned 6 in air or oxygen to generate heat without first having been stored. The stored hydrogen is transferred 5 to be likewise burned 6 in air or oxygen to generate heat. The resulting heat is transferred 7 to a farmhouse or a crop dryer. Oxygen generated by water electrolysis 2 is transferred 8 to support the efficient combustion 6 of hydrogen whenever water is being electrolyzed 2 and hydrogen is being burned 6. FIG. 2 shows the preferred embodiment of the hydrogen storage device. A balloon 11, about 30 ft in diameter and about 125 ft long when fully inflated, and preferentially made of metallized polyethalene phthalte polymer film, is partially or totally inflated with hydrogen gas 13 at near-ambient temperature and pressure.

The balloon is made of 88-gauge heat-sealable, metallized polyethylene phthalate polymer film (brand name Melinex) with a thickness of 0.00088 inch. The film is a commercial item made by, among others, the Dunmore Corporation in Bristol, Pa. and is sold as type DC040 Melinex. It comes in a width of 74 inches and in any desired length up to 20,000 yards. Its tensile strength is 37,000 poi, its rated elongation is 100%, it is metallized to an optical density of 2.5 to 3.0 using a Tobias TBX densitometer, it weighs one pound per 286 square feet, and it currently costs about 30 cents per linear yard. For the 30 ft. diameter by 125 ft. length of the preferred embodiment, the film costs less than $250. This is economically negligible compared to the total cost of the storage device and system.

The balloon can be assembled on site by heat-sealing horizontal strips of film along the intended length of the balloon and vertical strips to form the end surfaces. To facilitate the heat-sealing process, the strips can be assembled with the help of a supporting frame, also known as a “buck”, over which the strips are pulled to slide horizontally during the sealing process. The preferred cross-section of the buck is a circle about 10% smaller than the cross-section of the fully assembled balloon.

The balloon is protected by a lightweight shield 12 preferentially assembled from thin-gauge steel sheets (27 or 28 gauge) bolted or riveted together by means of long, narrow steel angles (not shown) placed along the length of shield 12. The sheets thus cover the entire perimeter of the shield which preferentially has an octagonal cross-section and is about 30 ft high & about 125 ft long. The spaces between adjacent steel sheets are lightly sealed with a commercial-type sprayed sealant (not shown), a type widely available and well-known to those skilled in the art. The function of the seals is to help shield the balloon from the elements, not to provide hermetic closure or pressurized containment, neither of which is necessary for this invention and either of which would be too expensive.

The two octagonal ends 26 of the shield are also made of thin-gauge steel sheets bolted or riveted together and spray-sealed like the steel sheets covering the length of the shield.

Hydrogen gas is blown into or out of the balloon through pipes 14 and 15. Gas flowmeter 16 feeds flow rate data electrically to gas volume totalizer 17. Flowmeter 16 measures both inflating and deflating flow rates, allowing the totalizer to keep track of the total net flow of hydrogen.

The air space 32 between the outside of the balloon and the inside of the shield is ventilated with outside air by means of blower 18 to prevent the possible accumulation of small amounts of hydrogen leaking into the air space. The ventilating air exhausts through pipe 19. Excessive accumulation of hydrogen in the air space is detected by means of hydrogen gas detector 20; excessive accumulation of oxygen within the balloon is detected by means of oxygen gas detector 21; and rapid evacuation of the balloon is effected, when either of the mixture compositions approaches the flammability threshold, by means of rapid release valve 22. Detectors 20 and 21 and valve 22 are commercial items well known to those skilled in the art.

For economic reasons, the leakage of hydrogen must be kept small over the period, typically months, during which hydrogen has to be stored. In the embodiment of FIG. 2, the use of a balloon with a 0.00088″-thick metallized polyethylene phthalate polymer skin results in a loss of hydrogen through leakage to the atmosphere of less than 1 standard cubic meter over a six month period. This is equivalent to a loss of less than 0.04% of the fully inflated volume of the balloon, which is economically insignificant.

The shield is anchored to the ground by means of anchors 23, 24, and 25, which are preferentially made of heavy-gauge steel. The shield is further secured by means of anchoring steel rods 9 and 10 and other similar one (not shown) along the length of the shield.

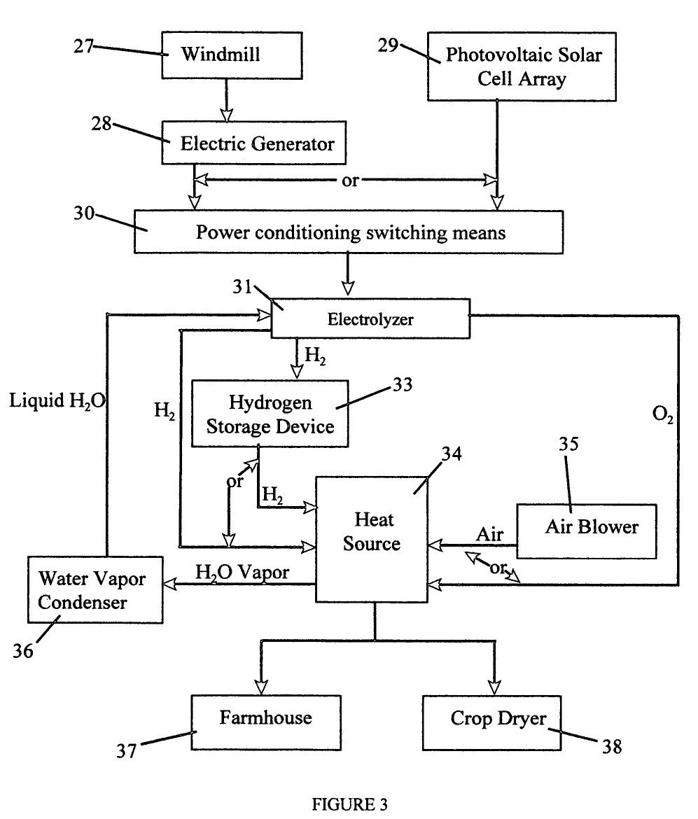

FIG. 3 shows the preferred embodiment of the system of the invention. A windmill or windfarm 27 powers an electric generator 28 which feeds electricity into power-conditioning means 30. Alternatively, the electricity flows from a photovoltaic solar array 29 into the power conditioner 30. Suitable power conditioners are commercially available and are well-known to those versed in the art. D.C. electricity flows into electrolyzer 31, a type of commercial device well-known in the art, where it generates hydrogen and oxygen from water. The hydrogen flows down either or both of two paths: one path leads to hydrogen storage device 33, the other directly to heat source 34. When the heat source needs more hydrogen than is produced by electrolyzer 31, additional hydrogen is supplied from hydrogen storage device 33 to the heat-source 34.

When both the electrolyzer 31 and the heat source 34 are active, the oxygen produced by the electrolyzer flows directly to the heat source. When the heat source is active but the electrolyzer is not, air blower 35 supplies combustion air to support the burning within the heat source of hydrogen coming out of storage. When the electrolyzer is active but the heat source is not, hydrogen flows into the storage device 33 while oxygen from the electrolyzer is vented and discarded.

When the heat source is active, heat is conveyed by conventional heat-transfer means, not shown but well-known in the art, to either farmhouse 37 or crop dryer 38 or in rare cases to both at the same time. Water vapor produced by the combustion of hydrogen in heat source 34 is condensed and collected in vapor condenser 36, a common type of commercial device; the resulting pure water is pumped to the electrolyzer 31 where it provides the renewable part of the pure water required for electrolysis to take place.

Since modifications and changes varied to fit particular operating requirements and environments will be apparent to those skilled in the art, the invention is not considered limited to the preferred embodiment chosen for purposes of disclosure, and covers all changes and modifications which do not constitute departures from the true spirit and scope of this invention.

Having thus described the invention, what is desired to be protected by Letters of Patent is presented in the subsequently appended claims.

What is claimed is:

1. A method for storing and releasing hydrogen gas at near-ambient temperature and pressure comprising:
a) providing a plurality of large inflatable and deflatable balloons whose skin is nearly impermeable to hydrogen;
b) gradually inflating each balloon with near-ambient temperature and pressure hydrogen gas produced by a renewable source of energy during months when little heat is needed from the combustion of said hydrogen;
c) gradually deflating each balloon by emptying its near-ambient temperature and pressure hydrogen gas during months when heat obtainable by burning said hydrogen is needed;
d) protecting the balloons in a space shielded against external causes of rupture;
e) piping said hydrogen gas from its point of generation to the storage balloons and to a hydrogen-burning heat source;
f) piping said hydrogen gas directly from said storage balloons to said hydrogen-burning heat source;
g) providing a sensor to measure the concentration of oxygen in said stored hydrogen;
h) providing a sensor to measure the concentration of hydrogen in the air within the shielded spaces surrounding the balloons;
i) providing means for rapidly emptying the balloons to the outside atmosphere if the sensed concentration of oxygen in the hydrogen ever approaches the hydrogen flammability threshold; and
j) providing means for rapidly emptying the balloons to the outside atmosphere if the sensed concentration of hydrogen in the air spaces within the protected spaces enclosing the balloons ever approaches the flammability threshold.

2. The method of claim 1, wherein the balloons are made of metallized polyethylene phthalate polymer film.

3. The method of claim 1, wherein the balloons are sized to store enough hydrogen to heat a farmhouse through most of the winter and heat a crop dryer through most of the harvest.

4. The method of claim 1, wherein the renewable source of energy comprises a windmill, an electric generator, and an electrolyzer.

5. The method of claim 1, wherein the renewable source of energy comprises photovoltaic solar cells and an electrolyzer.

6. The method of claim 1, wherein the balloons are housed within thin-walled, rigid, protective shields made of materials selected from the class comprising metal, concrete, cement, plastics, and composites.

7. The method of claim 6, wherein the protective shields are unpressurized and ventilated to the atmosphere.

8. The method of claim 6, wherein the protective shields are hollow cylinders.

9. The method of claim 6, wherein the protective shields are tubes having a polygonal cross-section.

10. The method of claim 6, wherein said shields protect the balloons against water, wind and snow.

11. A storage device for providing gaseous hydrogen to hydrogen-burning heat sources, the storage device comprising:
a) an inflatable and deflatable balloon whose skin is nearly impermeable to hydrogen and having at least one gas-conveying opening;
b) a volume of gaseous hydrogen stored within said balloon at near-ambient temperature and pressure;
c) a rigid shield for protecting said balloon against rupture; and
d) means of piping hydrogen gas to and from the balloon.

12. The device of claim 11, wherein the balloon skin is made of metallized polyethylene phthalate polymer film.

13. The device of claim 11, wherein said rigid shield is arranged to protect the balloon against water, snow and wind.

14. The device of claim 11, wherein said rigid shield is ventilated to the atmosphere.

15. The device of claim 11, wherein said rigid shield is a hollow cylinder.

16. The device of claim 11, wherein the said rigid shield is a tube whose cross-section is a regular polygon.

17. The device of claim 11, wherein the walls of the rigid shield are selected from the class of materials comprising metal, concrete, cement, plastics, and composites.

18. The device of claim 11, further comprising:
a) a sensor to monitor the oxygen concentration inside the balloon;
b) sensor to monitor the hydrogen concentration in the air space inside the rigid shield;
c) a safety relief valve for the rapid release of hydrogen from the balloon to the atmosphere when one of the sensors detects a gas composition approaching a flammability threshold;
d) a hydrogen flowmeter; and
e) a hydrogen volume totalizer

19. A system for generating, storing, releasing, and burning hydrogen gas, comprising:
a) a source of electricity powered by a renewable form of energy;
b) a switch means, including control means, connecting the electrical output of said source of electricity to an electrolyzer;
c) an electrolyzer adapted to dissociate water into hydrogen and oxygen by electrolysis;
d) a device for storing hydrogen gas at near-ambient temperature and pressure during any one season and releasing it in a subsequent season;
e) means to generate heat by burning said stored hydrogen gas;
f) means of transferring hydrogen gas from said electrolyzer to said hydrogen gas storing device and to said hydrogen-burning heat-generating means; and
g) means of transferring heat from said heat-generating means to a heat-consuming structure.

20. A system according to claim 19, wherein said source of electricity is an electric generator powered by a windmill.

21. A system according to claim 19, wherein said source of electricity is an array of photovoltaic solar cells.

22. A system according to claim 19, wherein said device for storing hydrogen is the device of claim 11.

23. A system according to claim 19, wherein said heat-consuming structure is a farmhouse.

24. A system according to claim 19, wherein said heat-consuming structure is a crop dryer.

25. A system according to claim 19, further comprising:
a) means of transferring oxygen gas to the heat-generating means of claim 19;
b) means to utilize said oxygen gas as the oxidant for the combustion of hydrogen in said heat-generating means;
c) means of condensing into pure water the water vapor produced by the combustion of hydrogen; and
d) means of conveying said pure water to said electrolyzer, to be electrolyzed into more hydrogen and more oxygen.
